(19) United States
(12) Patent Application Publication
(10) Pub. No.: US 2007/0269232 A1
(43) Pub. Date: Nov. 22, 2007

(54) Method for installing replacement optical photo conductor

(75) Inventors: Colin Davison, Hong Kong (CN); Lester Cornelius, Oyster Bay, NY (US)

Correspondence Address: Charles E. Temko, Esq., 22 Marion Road, Westport, CT, 06880, US

(73) Assignee: Optical Technologies Corp.

(21) Appl. No.: 11/715,116

(22) Filed: Mar. 8, 2007

Related U.S. Application Data
(60) Provisional application No. 60/801,560, filed on May 19, 2006.

(51) Int. Cl. G03G 15/00

(52) U.S. Cl. 399/109

(57) ABSTRACT

A method for installing a replacement optical photo conductor cylinder in a recycled toner cartridge having a frame for an electrostatic copier or similar device where the original photo conductor is permanently installed in the frame forming a part of the toner cartridge. The method includes the steps of removing the original cylinder by cutting it into as many segments as is necessary, providing a bushing within the original non-driven socket in the frame, providing the non-driven end of the replacement cylinder with a cap having a bore therein, inserting the replacement cylinder into operative position in the frame, and inserting a headed pin through the bushing and the cap to provide a bearing.

Related application reference is made to co-pending application Ser. No. 60/801,560; filed Apr. 19, 2006 to which a claim of priority is made.

### BACKGROUND OF THE INVENTION

This invention relates generally to the field of electrophotographic printers, copiers, etc. and more particularly to the field of recycling exhausted replaceable toner cartridges used with such devices.

In the present state of the art, many copiers are provided with replaceable cartridges which include all of the parts which are depleted with copier use. User replacement at periodic intervals often eliminates the need for technical servicing, or the inconvenience of downtime. Replacement cartridges are normally available from the manufacturer, but are fairly expensive. Not surprisingly, a cartridge recycling industry has developed, rebuilding used toner cartridges which cost only a fraction of a new cartridge.

Among the frequently replaced parts is the optical photo conductor cylinder which rotates during the copying cycle. In some construction, this cylinder is mounted for rotation in a frame forming part of the cartridge, and not intended to be replaced as a separate element. The present invention is directed toward overcoming this problem. It has particular application for cartridges currently distributed for Hewlett Packard's HP 2800 printer.

### SUMMARY OF THE INVENTION

Briefly stated, the invention relates to the provision of an improved method for removing the original photo conductor cylinder, and replacing it with a new cylinder in cartridges for the Hewlett Packard HP 2600 copier and similar type cartridges. The method comprises cutting the original cylinder into as many parts as are necessary to permit removal, providing a replacement end cap for the new cylinder at the non-driven end having a pin receiving bore, providing a plastic bushing having a bore at the non-driven end, inserting the same into the recess which supported the non-driven end of the original cylinder, and inserting a pin through the bushing and end cap after the new cylinder is positioned.

### BRIEF DESCRIPTION OF THE DRAWING

In the drawings, to which reference will be made in the specifications, similar reference characters have been employed to designate corresponding parts throughout the several views.

FIG. 1 is a view in perspective showing a conventional method of installation of an optical photo conductor cylinder forming part of a known toner cartridge.

FIG. 2 is a view in perspective showing a first step in the disclosed method of installing a replacement optical photo conductor cylinder.

FIG. 3 is a view in perspective showing a final step in the disclosed method.

### DETAILED DESCRIPTION OF THE DISCLOSED METHOD

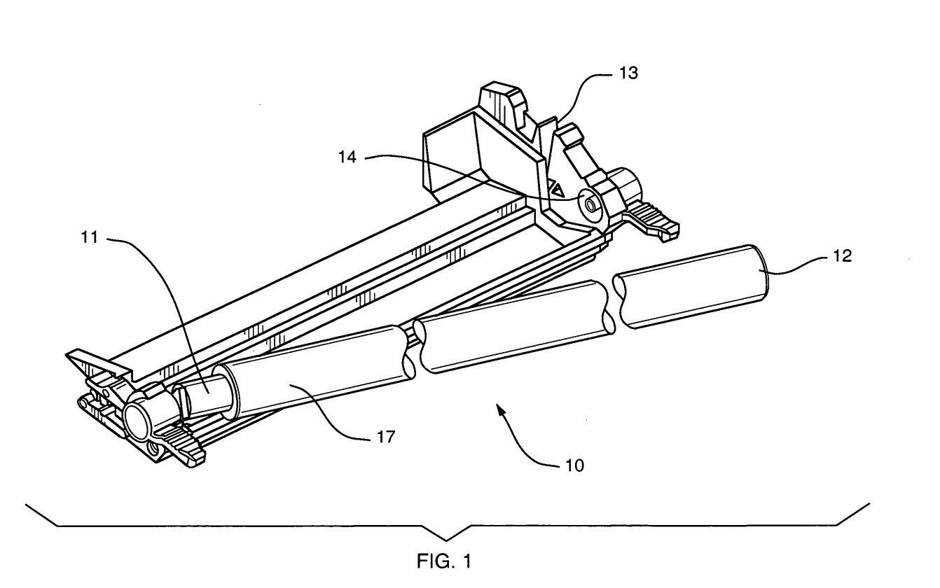

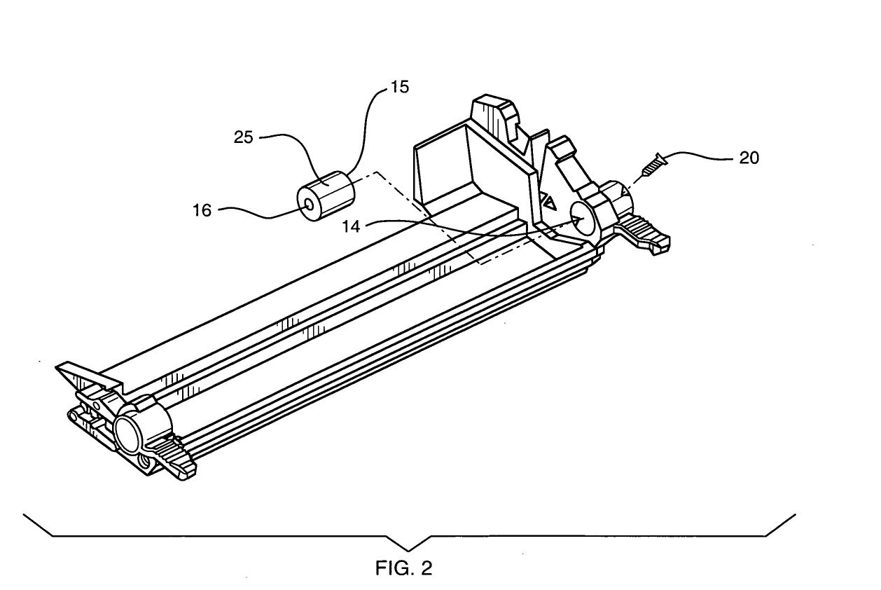

With reference to FIG. 1 in the drawings, reference character 10 designates a known optical photo conductor cylinder which forms a part of a toner cartridge. It includes a driven first end 11 and a second non-driven end 12. The original frame 13 forms a socket 14 which serves as a bearing for the original cylinder. A plastic bushing 15 (FIG. 2) is inserted in this socket to be maintained by a set screw 20 and includes an axially disposed bore 16.

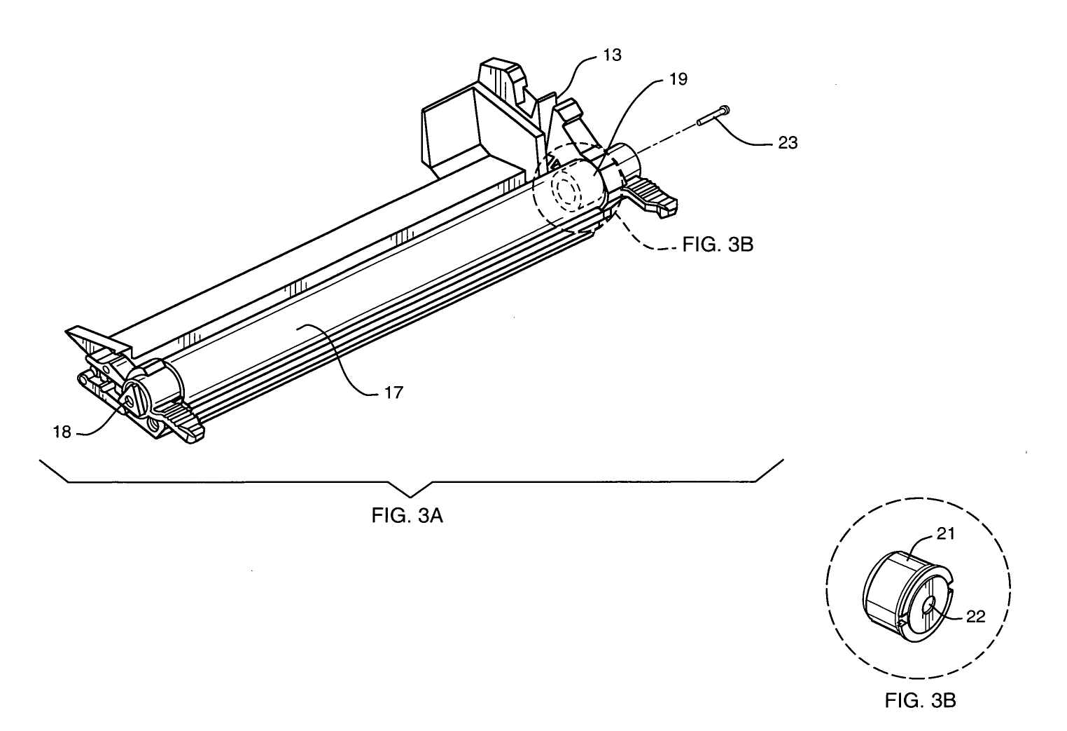

Referring to FIGS. 2 and 3 in the drawing, a replacement cylinder 17 includes a first driven end 18 similar to the original and a non-driven end 19 having a replacement end cap 21 having a axial bore 22 for receiving a connecting pin 23.

The method is commenced by cutting the original cylinder into as many pieces as necessary to permit easy removal. Next the bushing 15 is inserted into the original socket 14 following which the replacement cylinder with its substitute end cap 21 is aligned. The connecting pin 23 is then inserted. It engages the bore in the bushing and the bore in the end cap of the replacement cylinder.

To summarize the method, as a first step the original cylinder is removed by cutting it in as many places as necessary to clear it for relatively easy removal as shown in FIG. 1. As a second step, the bushing 15 is inserted as shown in FIG. 2 to be permanently maintained by a set screw 20 which engages one of the slots 25 in the bushing 15. A third step is the positioning of the replacement end cap 21 in the replacement cylinder, following which the replacement cylinder is positioned as shown in FIG. 3.

With a subsequent recycling of the toner cartridge, the next replacement cylinder is easily installed. All that is necessary is the removal of the headed pin enabling the replacement cylinder to be disconnected without the necessity of cutting the cylinder, and positioning the new replacement cylinder to be engaged by the reinserting of the pin 23.

It may thus be seen that we have invented novel and highly useful improvements in recycling copier toner replacement cartridges in which provision has been made for rebuilding original equipment cartridges. Replacement parts, other than the optical photo conductor cylinder are relatively inexpensive, and only ordinary tools and skills are required.

We wish to be understood that we do not consider the invention to be limited to the precise details of structure, illustrated and described in the specification for obvious modification will occur to those skilled in the art for which the invention pertains.

We claim:

1. The method for installing an optical photo conductor cylinder as a replacement for an original optical photo conductor cylinder in a recycled toner cartridge having a frame and a socket therein supporting a non-driven end of said original cylinder comprising the steps of:
(a) cutting said original cylinder in as many parts as necessary to permit removal;
(b) removing said original cylinder;
(c) providing a bushing, having a axially disposed bore therein, and positioning the same within said socket holding a non-driven end of the original cylinder, and an end cap having a axially disposed bore;
(d) positioning said replacement cylinder in coaxial relation to said bushing; and
(e) providing and inserting a headed pin into the axially aligned bores of said bushing and said end cap to retain said replacement cylinder into position for driven rotation, at an opposite end of said replacement cylinder.

2. In the method in accordance with claim 1, the additional step of:
(f) providing a set screw penetrating said socket for retaining said bushing in installed position.

3. In a toner cartridge for electrophotographic copiers including a frame element, a rotationally mounted photo conductor cylinder supported by said frame element having a driven first and a second non-driven end, the improvement comprising:
Said non-driven end having an end cap defining a coaxially aligned first bore, said frame defining a socket, a bushing positioned within said socket, said bushing having a second axially aligned bore communicating with said first bore, a headed pin engaging said first and second bores to form a bearing; whereby said cylinder maybe engaged and disengaged by insertion and removal of said headed pin.
